(19) United States
(12) Patent Application Publication
(10) Pub. No.: US 2007/0019620 A1
(43) Pub. Date: Jan. 25, 2007

(54) Monitoring of coded data

(75) Inventor: Surender Surana, Budapest (HU)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/280,562

(22) Filed: Nov. 15, 2005

(30) Foreign Application Priority Data
Jul. 21, 2005 (EP) 05015893.0

(51) Int. Cl. H04Q 7/00; H04L 12/66

(52) U.S. Cl. 370/352; 370/328

(57) ABSTRACT

The present invention relates to a gateway node (20) and a monitoring method of monitoring data exchange between at least two subscribers in a communication network. A coding information indicating at least one of a coding type and rate-adaptation mechanism applied by the at least two subscribers is stored at the gateway node (20), and a copy of exchanged data is processed at the gateway node (20) using the stored coding information. Then, the processed copy of the exchanged data is delivered to a monitoring function. Thereby, a delivery function for the monitored data can be implemented in a gateway device or node. This leads to a reduced signaling and processing load and the monitoring function or apparatus does not require any coding information.

### CROSS-REFERENCE TO RELATED APPLICATION

This application claims priority under 35 USC §119 to European Patent Application No. 05015893.0 filed on Jul. 21, 2005.

### FIELD OF THE INVENTION

The invention relates to a media gateway node and method of monitoring payload data exchange between at least two subscribers in a communication network, such as a third generation (3G) mobile network.

### BACKGROUND OF THE INVENTION

Document WO 01/47222 discloses a monitoring system using a Legal Intercept Monitoring Centre (LIC) for intercepting communication in a Public Land Mobile Network (PLMN). This known system allows monitoring acoustic content of a speech channel as law enforcement authorities get PCM (Pulse Code Modulation) encoded speech.

However, if a so-called Tandem Free Operation (TFO) is set, compressed voice frames are exchanged between subscriber terminals. If the Tandem Free Operation is kept during the monitoring operation, the law enforcement authorities are only provided with a compressed PCM stream. As this PCM stream is not a true copy of the originally encoded voice data, the subscribers could transmit data in the compressed mode which will be missed by the law enforcement authorities. If TFO is cancelled for each monitored call in order to provide the law enforcement authorities with the originally encoded voice, then the two subscribers could detect the drop of Tandem Free Operation due to the resulting different speech quality. They can take this as an indication that their call is monitored.

If a 3G mobile network has been designed and implemented in 3GPP (3^{rd} Generation Partnership Project) Release 4 architecture, a TFO setting can be activated. In this case, however, when an end user or subscriber initiates a TFO call to another terminal, then both terminals select a data rate suitable for communication. Consequently, exchanged voice is coded and/or rate-adapted in the mobile network. Now if a lawful enforcement agency wants to listen to or monitor this call, it is not possible as the voice is coded and authorities have no clue about the used codec or rate adaptation mechanism.

Document EP1307036A1 discloses a telephone system with at least one monitoring apparatus for monitoring payload data exchanged between at last two subscribers. A network node is provided to send to the monitoring apparatus an information on the codec type that has been selected by the at least two subscribers for their call. Thereby, a copy of the payload data can be sent unmodified to the monitoring apparatus. In particular, the general idea is that between the at least two subscribers only calls of a certain speech codec type are established for which a corresponding codec type is available in the monitoring apparatus, while the list of codec types that are available at the monitoring apparatus may be kept up-to-date by regular polling operations or update services. Due to the fact that an up-to-date codec list is provided at the monitoring apparatus, coded speech data can be forwarded in a transparent manner to the monitoring apparatus, to be decoded there.

However, the above monitoring system requires regular updates of the list of codec types and/or codec negotiations between the at least two subscribers and the monitoring apparatus, to ensure that codec types listed at the monitoring apparatus are used. This leads to an undesired increase in signaling and processing load.

### SUMMARY OF THE INVENTION

It is an object of the invention to provide a monitoring mechanism, by means of which signaling and processing load can be reduced.

This object is achieved by a gateway node for a communication network with at least one monitoring apparatus for monitoring data exchange between at least two subscribers, said gateway node comprising:
storing means for storing coding information indicating at least one of a coding type and rate-adaptation mechanism applied by said at least two subscribers;
decoding means for selectively decoding a copy of data exchanged between said at least two subscribers, using said stored coding information; and
delivering means for delivering the decoded copy of said data to said monitoring apparatus.

Furthermore, the above object is achieved by a method of monitoring data exchange between at least two subscribers in a communication network, said method comprising the steps of:
storing at a gateway node coding information indicating at least one of a coding type and rate-adaptation mechanism applied by said at least two subscribers;
selectively decoding a copy of exchanged data at said gateway node using said stored coding information; and
delivering the decoded copy of said exchanged data to a monitoring function.

Accordingly, a delivery function for the monitored data can be implemented in a gateway device or node. The gateway node keeps a record of the required coding information used by the communicating terminal devices and is thus in a position to apply decoding and/or rate adaptation processing if an on-going call is intercepted by authorities. The processed content is then delivered to the monitoring function or apparatus of the authorities, so that provision, update and/or negotiation of the coding information at the monitoring function or apparatus is no longer required. This leads to a reduced signaling and processing load and the monitoring function or apparatus does not require any coding information.

As an example, the transcoder-free mode of operation may be a Tandem Free Operation as defined in 3G mobile networks.

Furthermore, the monitoring function may comprises a law enforcement monitoring function implemented by a law enforcement agency or authority.

The coding information is received at the gateway node in a signaling message of a mobile switching center.

As a specific implementation example, the invention may be implemented as a computer program product comprising code means stored on a readable medium, the code means adapted to produce the above method steps when run on a computer device. Alternatively, the method steps may be executed at corresponding hardware units or functionalities.

Further advantageous developments are defined in the dependent claims.

### BRIEF DESCRIPTION OF THE DRAWINGS

In the following, the present invention will be described based on an embodiment with reference to the accompanying drawings in which:

FIG. 1 shows call establishment schematic in a network architecture according to the embodiment where a media gateway node is provided with full codec support; and

FIG. 2 shows a schematic block diagram of the media gateway according to the embodiment.

### DESCRIPTION OF THE EMBODIMENT

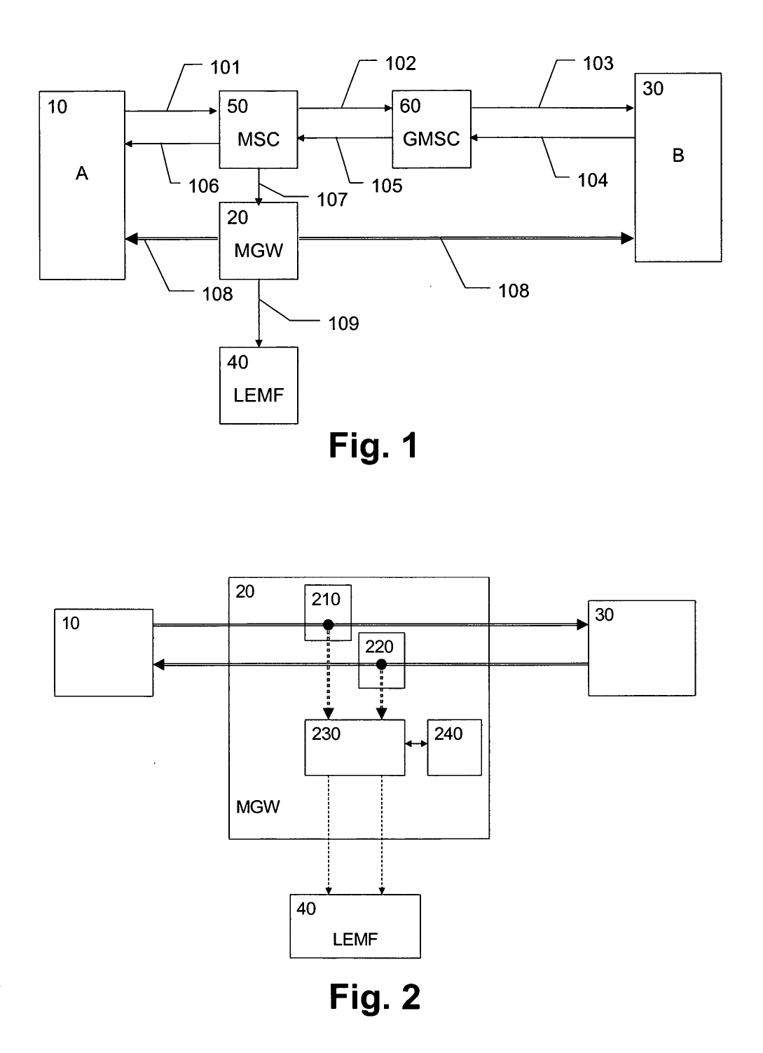

FIG. 1 shows a schematic architecture of a mobile network for the case that a first subscriber A wants to call a second subscriber B. A mobile terminal 10 of the first subscriber A sends a list of codec types it supports via a message, such as Supported_Codecs, to a network node that handles the call (signaling step 101). In case of a Third Generation Partnership Project (3GPP) system the function of controlling the establishment, maintaining and releasing a call is located in so-called mobile switching center (MSC) 50. The MSC 50 to which the first subscriber A is assigned forwards the message to a Gateway MSC (GMSC) (signaling step 102) to which the called subscriber is assigned. The GMSC is a switch at the point where the PLMN is connected to an external circuit-switched network. All incoming and outgoing connections go through the GMSC 60.

The GMSC forwards the message to a mobile terminal 30 of the second subscriber B (signaling step 103). The second subscriber B compares the received list of codec types of the first subscriber A with the list of codec types that is supported by the second subscriber B. Typically, a codec type which is common to both subscribers and which provides the best quality is selected. A coding information indicating the selected codec type is transmitted in a dedicated message, such as a Selected_Codec message, back to the GMSC 60 (signaling step 104), from there to the MSC 50 (signaling step 105), and from there to the terminal device 10 of the first subscriber A (signaling step 106).

3GPP has defined a so-called Tandem Free Operation (TFO) to provide codec transparency when originating and terminating parties support the same codecs. 3GPP has further defined Out of Band Transcoder control, also called Transcoder Free Operation (TrFO) in network access cases to provide both codec transparency and bandwidth savings when a core network architecture is used. In TrFO, the transcoders in the core network are effectively bypassed and inserted only when the core network needs it for inter-working reasons.

In the above case, it is assumed that both subscribers A and B support a common codec type. Hence, a tandem free operation (TFO) can be estabished that provides highest possible quality due to the fact that no transcoding is necessary within the switched call path.

Additionally, a media gateway (MGW) 20 is provided, which terminates bearer channels from a circuit-switched network domain and media streams from a packet network domain. The bearer control and payload processing capabilities of the MGW 20 also need to support mobile specific functions such as relocation/handover and anchoring. At a minimum, echo cancellation and automatic level control are required for speech quality. Regulatory requirements such as Lawful Interception are also supported.

In a TFO case, the media gateway (MGW) 20 which handles the payload data exchange of the established call is informed by the MSC 50 about the selected codec type, e.g. by sending the above or a corresponding coding information in signaling step 107. The MGW 20 stores the received coding information and copies the payload data, e.g. the speech data from the first subscriber A of the call to the second subscriber B of the call and vice versa (data exchange 108).

As the MGW 20 is provided with all up-to-date codec types it is able to decode the received data as it also has been informed about the selected codec type. In the instant the coding information message arrives at the MSC 50, e.g. in the Selected_Codec message, the MSC—in case the call should be monitored—informs the MGW 20 about the codec type that has been agreed by the two subscribers A and B.

For 3GPP network systems, the existing lawful interception architecture is described in the 3GPP specification TS 33.107. A law enforcement monitoring functions (LEMF) 40 is typically a national specific monitoring device or apparatus which is not defined by 3GPP. Delivery functions adopt the standardized interfaces of the 3G call control servers to the national interfaces HI1, HI2, HI3 of the LEMFs.

Thus, the delivery function for delivering copied data to the LEMF 40 can be implemented in the MGW 20. To achieve this, the MGW 20 keeps a record of codecs used by the mobile terminals 10, 30 and/or rate adaptation methods applied there. If an on-going call is intercepted by interception authorities, the call content can be de-coded and/or rate-adapted at the MGW 20 and a noncoded or non-ciphered and/or non-rate-adapted content can be delivered to the interception authorities, e.g., the LEMF 40 (signaling step 109).

FIG. 2 shows a schematic block diagram of the MGW 20 and its basic functionalities in connection with the present invention.

During the ongoing call the MGW 20 copies the data received from each subscriber A, B by respective branching functions or units 210, 220 and forwards the copied data to a processor or processing unit 230 arranged for applying a decoding and/or rate-adaptation processing to the copied data. Additionally, a memory or memory unit 240 is provided at the MGW 20 for storing received coding information comprising or indicating at least one of a codec list, a selected or agreed codec, and a rate adaptation method. This coding information is derived from the respective signaling received from the MSC 50 and used by the processing unit 230 to apply the above decoding and/or rate-adaptation processing. At least one of the branching units 210, 220, the processing unit 230 and the memory unit 240 may be implemented as at least one software routine comprising code means adapted to control a computer device of the MGW 20 to perform the respective processing steps. The at least one software routine may be stored on a computer-readable medium or may be downloaded from a network.

The decoded and/or rate-processed copied data of both data exchange directions between the two terminals 10, 30 can be forwarded to the LEMF 40, e.g., via an ×3 interface and a Delivery Function DF3 to the LEMF 40 which can be now easily monitored the copied data without requiring any up-to-date codec list.

It is however noted that the present invention is not restricted to the above specific embodiment. That is, on the basis of the teaching contained in the description, various modifications and variations of the invention may be carried out. In particular, the present invention is not restricted to mobile networks and media gateway devices, but can be implemented in any network environment where at least one gateway node is provided, through which monitored coded or rate-adapted data can be copied. The above embodiment may thus vary within the scope of the attached claims.

What is claimed is:

1. A gateway node for a communication network with at least one monitoring apparatus (40) for monitoring data exchange between at least two subscribers, said gateway node (20) comprising:
a) storing means (240) for storing coding information indicating at least one of a coding type and rate-adaptation mechanism applied by said at least two subscribers;
b) processing means (230) for selectively processing a copy of data exchanged between said at least two subscribers, using said stored coding information; and
c) delivering means (230) for delivering the processed copy of said data towards said monitoring apparatus (40).

2. The node of claim 1, wherein said gateway node is a media gateway (20) of a mobile network.

3. The node of claim 2, wherein said coding information indicates a list of codecs used by said at least two subscribers in a transcoder-free mode of operation.

4. The node of claim 3, wherein said transcoder-free mode of operation is a Tandem Free Operation.

5. The node of claim 1, wherein said monitoring apparatus comprises a law enforcement monitoring function.

6. The node of claim 1, wherein said coding information is received in a signaling message of a mobile switching center.

7. The node of claim 1, wherein said coding information indicates a list of codecs used by said at least two subscribers in a transcoder-free mode of operation.

8. The node of claim 7, wherein said transcoder-free mode of operation is a Tandem Free Operation.

9. A method of monitoring data exchange between at least two subscribers in a communication network, said method comprising the steps of:
a) storing at a gateway node (20) coding information indicating at least one of a coding type and rate-adaptation mechanism applied by said at least two subscribers;
b) selectively processing a copy of exchanged data at said gateway node (20) using said stored coding information; and
c) delivering the processed copy of said exchanged data to a monitoring function.

10. The method of claim 9, wherein said gateway node is a media gateway (20) of a mobile network.

11. The method of claim 10, wherein said coding information indicates a list of codecs used by said at least two subscribers in a transcoder-free mode of operation.

12. The method of claim 11, wherein said transcoder-free mode of operation is a Tandem Free Operation.

13. The method of claim 9, wherein said monitoring function comprises a law enforcement monitoring function.

14. The method of claim 9, wherein said coding information is received in a signaling message of a mobile switching center.

15. The method of claim 9, wherein said coding information indicates a list of codecs used by said at least two subscribers in a transcoder-free mode of operation.

16. The method of claim 15, wherein said transcoder-free mode of operation is a Tandem Free Operation.

17. A computer program product comprising code means stored on a readable medium, the code means adapted to produce the steps of method claim 9 when run on a computer device.

18. A gateway node for a communication network with at least one monitoring apparatus (40) for monitoring data exchange between at least two subscribers, said gateway node (20) comprising:
a) a memory;
b) coding information stored in said memory, the coding information indicating at least one of a coding type and rate-adaptation mechanism applied by said at least two subscribers; and
c) a processor in communication with said memory, the processor selectively processing a copy of data exchanged between said at least two subscribers, using said stored coding information and for delivering the processed copy of said data towards said monitoring apparatus (40).

19. The node of claim 18, wherein said gateway node is a media gateway (20) of a mobile network.

20. The node of claim 18, wherein said coding information indicates a list of codecs used by said at least two subscribers in a transcoder-free mode of operation.

21. The node of claim 20, wherein said transcoder-free mode of operation is a Tandem Free Operation.

22. The node of claim 18, wherein said monitoring apparatus comprises a law enforcement monitoring function.

23. The node of claim 18, wherein said coding information is received in a signaling message of a mobile switching center.
